(19) United States
(12) Patent Application Publication
(10) Pub. No.: US 2020/0156969 A1
(43) Pub. Date: May 21, 2020

(54) DEWATERING FLOCCULATED TAILINGS

(71) Applicant: SYNCRUDE CANADA LTD. in trust for the owners of the Syncrude Project as such owners exist now and in, Fort McMurray (CA)

(72) Inventors: RANDY MIKULA, Edmonton (CA); ADEDEJI DUNMOLA, Edmonton (CA); NAN WANG, Edmonton (CA); BARRY BARA, Edmonton (CA); JONATHAN SPENCE, Edmonton (CA)

(21) Appl. No.: 16/687,436

(22) Filed: Nov. 18, 2019

Related U.S. Application Data
(60) Provisional application No. 62/769,416, filed on Nov. 19, 2018.

(51) Int. Cl. C02F 1/56; C02F 1/52; C10G 33/04; C02F 103/10

(52) U.S. Cl. CPC C02F 1/56; C02F 2103/10; C10G 33/04; C02F 1/5227

(57) ABSTRACT

A process for dewatering tailings is provided, comprising mixing the tailings with an effective amount of a flocculant to form flocculated tailings; providing a containment area having a water column therein; and depositing the flocculated tailings into the containment area such that the flocculated tailings pass through the water column to allow the flocs to form a compact structure at the bottom thereof.

### FIELD OF THE INVENTION

The present invention relates to a process for dewatering tailings. In particular, tailings are treated with a flocculant to form larger structures (flocs) that can be efficiently separated from the water when deposited in a deposition/containment area having a pre-existing water column.

### BACKGROUND OF THE INVENTION

Extraction tailings, such as oil sand extraction tailings, are generated from extraction operations that separate valuable material from the mined ore. In the case of oil sand ore, heavy oil or bitumen is extracted from the ore using water, which is added to the oil sand ore to enable the separation of the valuable hydrocarbon fraction from the oil sand minerals.

Oil sand generally comprises water-wet sand grains held together by a matrix of viscous heavy oil or bitumen. Bitumen is a complex and viscous mixture of large or heavy hydrocarbon molecules that contain a significant amount of sulfur, nitrogen and oxygen. The extraction of bitumen from oil sand using hot water processes yields extraction tailings composed of coarse sand, fine silts, clays, residual bitumen and water. Mineral fractions with a particle diameter less than 44 microns are herein referred to as “fines.” These fines are typically clay mineral suspensions, predominantly kaolinite and illite.

Conventionally, extraction tailings have been transported to a deposition site contained within a dyke structure generally constructed by placing the coarse sand fraction of the tailings on beaches. The process water, unrecovered hydrocarbons, together with sand and fine materials that are not trapped in the dyke structure flow into a pond, where the coarse sand settles quickly to the bottom of the pond while the finer mineral solids remain in suspension.

The fine tailings suspension is typically 85% water and 15% fine particles by mass. Dewatering of fine tailings occurs very slowly. When first discharged in ponds, the very low density material is referred to as thin fine tailings. After a few years when the thin fine tailings have reached a solids content of about 30-35%, they are referred to as mature fine tailings (MFT), which behave as a fluid-like colloidal material. MFT, which has a low solids to fines ratio (<0.3), is often referred to as a type of fluid fine tailings (FFT). FFT is generally defined as a liquid suspension of oil sands fines in water with a solids content greater than 2% and having less than an undrained shear strength of 5 kPa.

The fact that fluid fine tailings behave as a fluid and have very slow settling/consolidation rates significantly limits options to reclaim tailings ponds. A challenge facing the industry remains the removal of water from the fluid fine tailings to strengthen the deposits so that they can be terrestrially reclaimed and no longer require containment.

One method for improving the dewatering of fluid fine tailings is to treat the tailings with a flocculant such as a high molecular weight nonionic, anionic, or cationic polymer to create a floc structure that will dewater rapidly when deposited in dewatering cells. However, after significant initial dewatering, subsequent water release in the treated tailings deposit still occurs slowly. Thus, there is a need for an improved method for dewatering treated tailings to reduce their water content to more quickly create dry stackable tailings that can be incorporated into terrestrial landscapes.

### SUMMARY OF THE INVENTION

The use of flocculants, in particular, polymeric flocculants, is becoming commonplace in oil sand tailings management. The flocculation process releases water from flocculated tailings through two main mechanisms: the release of inter-floc water (water between neighboring flocs) as the flocculated tailings settle and the subsequent release of intra-floc water (water within each floc) as the flocs are compressed and consolidate.

It was surprisingly discovered that by depositing flocculated tailings in a deposition site having a pre-existing water column and allowing the flocculated tailings to settle through the water column, the flocs compact at a faster rate when compared to depositing the tailings sub-aerially. It is counterintuitive to think that depositing flocculated tailings into a water column, which may result in diluting the tailings with water during deposition, can enhance dewatering; however, by passing the flocculated tailings through a water column, the flocs may have time to orient in a more optimally dewatering configuration, maximizing the rate of release for inter-floc water. Conventional operations would try to deposit the relatively dense flocculated mixture into existing MFT or below the mudline of the deposit that is being formed in order to minimize floc shearing. This conventional approach creates a deposit that traps a significant fraction of the inter-floc water, significantly slowing the initial densification and consolidation process.

Addition of polymeric flocculants to tailings, in particular, to oil sand fluid fine tailings, produces large flocs and, hence, significant inter-floc water, i.e., the water between neighboring flocs. The bulk of the inter-floc water is easily removed, resulting in a densification or increase in solids content of the resulting flocculated tailings. However, there is limited opportunity for arrangement of flocs in directly deposited treated tailings, and this can limit or perhaps stop the escape of the inter-floc water. On the other hand, when the flocs are allowed to drop through a water column, there can be a greater opportunity for the flocs to form a more compact structure with a minimum of inter-floc water, thus, optimize the inter-floc water release. Hence, by dropping the treated tailings through a water column, this will allow for a more efficiently arrangement of the flocs, with less inter-floc water and, ultimately, a denser deposit.

The present invention is particularly useful with, but not limited to, fluid fine tailings (FFT) such as MFT. Thus, a process is provided for dewatering tailings, comprising:
mixing the tailings with an effective amount of a flocculant to form flocculated tailings;
providing a containment area having a water column therein;
depositing the flocculated tailings into the containment area such that the flocculated tailings pass through the water column to allow the flocs to form a compact structure below the water column.

In one embodiment, the water column is removed after deposition is completed. In another embodiment, the water column remains in the containment area. When completely saturated with a constant water cover, the deposit densifies and gains strength mainly through self-weight consolidation. When the water column is removed, top-boundary flux mechanisms such as evaporative drying and thaw strain may contribute to deposit dewatering performance.

In one embodiment, the flocculant and tailings are mixed in a pipe having an in-line dynamic or static mixer. In another embodiment, the flocculant and tailings are mixed in a mixing tank. In another embodiment, the tailings are pre-treated with an inorganic multivalent cation such as calcium, aluminium, etc. in order to pre-treat the clay component of the tailings. This is done prior to the addition of the flocculant in order to enhance flocculant performance.

In one embodiment, the tailings are oil sand fluid fine tailings, including MFT, having a solids content in the range of about 10 wt. % to about 45 wt. %. In another embodiment, the tailings have a solids content in the range of about 30 wt. % to about 45 wt. % (MFT).

In one embodiment, the flocculant is a water soluble polymer having a moderate to high molecular weight and an intrinsic viscosity of at least 3 dl/g (measured in 1N NaCl at 25° C.). The polymeric flocculant may be cationic, non-ionic, amphoteric, or anionic. The polymeric flocculant can be in an aqueous solution at a concentration of about between 0.05 and 5% by weight of polymeric flocculant. Typically, the polymeric flocculant solution will be used at a concentration of about 1 g/L to about 5 g/L.

Suitable doses of polymeric flocculant can range from 10 grams to 10,000 grams per tonne of oil sands fine tailings. Preferred doses range from about 400 to about 1,000 grams per tonne of oil sands fine tailings.

In one embodiment, the flocculant is a charged or uncharged polyacrylamide such as a high molecular weight polyacrylamide-sodium polyacrylate co-polymer with about 25-35% anionicity. The polyacrylamide-sodium polyacrylate co-polymers may be branched or linear and have molecular weights that can exceed 20 million.

In one embodiment, the water column is at least 0.5 m deep. In another embodiment, the water column is at least 1 m deep.

### BRIEF DESCRIPTION OF THE DRAWINGS

Referring to the drawings wherein like reference numerals indicate similar parts throughout the several views, several aspects of the present invention are illustrated by way of example, and not by way of limitation, in detail in the figures, wherein:

FIG. 1 is a schematic of one embodiment of the present process for dewatering flocculated tailings.

### DETAILED DESCRIPTION OF THE PREFERRED EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

The present invention relates generally to a process for dewatering tailings. In particular, tailings are treated with a flocculant to form larger structures (flocs) that can be efficiently separated from the water when deposited in a deposition area having a water column therein. When the flocs are allowed to drop through a water column, there is an opportunity to form a structure with a minimum of inter-floc water and to optimize the inter-floc water release, resulting in a densification or increase in solids content of the flocculated tailings. Without being bound to theory, it is believed that there is limited opportunity for arrangement of flocs in the directly deposited treated tailings. This results in the trapping of water in the inter-floc structure that is haphazardly formed with the deposition of relatively dense flocculated tailings. However, dropping the flocculated tailings through a water column allows the flocs more time to optimally orient themselves, resulting in a more efficient arrangement of the flocs, with less inter-floc water and a denser deposit. This has the potential to significantly improve both the initial and ultimate dewatering of a flocculated tailings deposit.

The process is particularly useful for treating tailings derived from oil sands extraction operations and containing a fines fraction, and dewatering the tailings to enable reclamation of tailings disposal areas and to recover water for recycling. As used herein, the term “tailings” means any extraction tailings that are generated from extraction operations that separate valuable material from mined ore, including tailings derived from oil sands extraction operations that contain a fines fraction. The term is meant to include fluid fine tailings (FFT) such as mature fine tailings (MFT) from tailings ponds and fine tailings from ongoing extraction operations (for example, thickener underflow or froth treatment tailings) which may bypass a tailings pond. The tailings are treated with a flocculant to aggregate the solids prior to dewatering in a containment area such as a deposition cell having a water column therein.

As used herein, a “water column” generally refers to a layer of water in a containment area such as a deposition cell that is measured from the surface of the water to the top surface of the material underlying the water layer. In other words, the water column is the layer of water that the flocs should travel through before hitting their final destination, for example, either above the containment area bottom, or clay liner, or top of active flocculated deposited material, or other tailings product.

As used herein, “inorganic multivalent cation” refers to a cation having more than one valence and include divalent and trivalent cations. Divalent cations useful in the present invention include, but are not limited to, calcium (Ca²⁺), magnesium (Mg²⁺), and iron (Fe²⁺). Trivalent cations useful in the present invention include, but are not limited to, aluminium (Al³⁺), iron (Fe³⁺). Inorganic multivalent cation can be added in the form of alum, aluminum chlorohydrate, aluminum sulphate, lime (calcium oxide), slaked lime (calcium hydroxide), calcium chloride, magnesium chloride, iron (II) sulphate (ferrous sulphate), iron (III) chloride (ferric chloride), sodium aluminate, gypsum (calcium sulphate dehydrate), or any combination thereof.

As used herein, the term “flocculant” refers to a reagent that bridges the neutralized or coagulated particles into larger agglomerates, resulting in more efficient settling. Flocculants useful in the present invention are generally anionic, nonionic, cationic or amphoteric polymers, which may be naturally occurring or synthetic, having relatively high molecular weights. Preferably, the polymeric flocculants are characterized by molecular weights ranging between about 1,000 kD to about 50,000 kD. Suitable natural polymeric flocculants may be polysaccharides such as dextran, starch or guar gum. Suitable synthetic polymeric flocculants include, but are not limited to, charged or uncharged polyacrylamides, for example, a high molecular weight polyacrylamide-sodium polyacrylate co-polymer.

Other useful polymeric flocculants can be made by the polymerization of (meth)acrylamide, N-vinyl pyrrolidone, N-vinyl formamide, N,N dimethylacrylamide, N-vinyl acetamide, N-vinylpyridine, N-vinylimidazole, isopropyl acrylamide and polyethylene glycol methacrylate, and one or more anionic monomer(s) such as acrylic acid, methacrylic acid, 2-acrylamido-2-methylpropane sulphonic acid (ATBS) and salts thereof, or one or more cationic monomer(s) such as dimethylaminoethyl acrylate (ADAME), dimethylaminoethyl methacrylate (MADAME), dimethydiallylammonium chloride (DADMAC), acrylamido propyltrimethyl ammonium chloride (APTAC) and/or methacrylamido propyltrimethyl ammonium chloride (MAPTAC).

In one embodiment, the flocculant comprises an aqueous solution of an anionic polyacrylamide. The anionic polyacrylamide preferably has a relatively high molecular weight (about 10,000 kD or higher) and medium charge density (about 20-35% anionicity), for example, a high molecular weight polyacrylamide-sodium polyacrylate co-polymer. The preferred flocculant may be selected according to the tailings composition and process conditions.

The flocculant is generally supplied from a flocculant make up system for preparing, hydrating and dosing of the flocculant. Flocculant make-up systems are well known in the art, and typically include a polymer preparation skid, one or more storage tanks, and a dosing pump. In one embodiment, the dosage of flocculant ranges from about 400 grams to about 1,500 grams per tonne of solids in the FFT. In one embodiment, the flocculant is in the form of a 0.4% solution.

As used herein, “fluid fine tailings” or “FFT” is a liquid suspension of oil sand fines in water with a solids content greater than 2%. “Fines” are mineral solids with a particle size equal to or less than 44μ. “Mature fine tailings” or “MFT” are FFT with a low sand to fines ratio (SFR), i.e., less than about 0.3, and a solids content greater than about 30%.

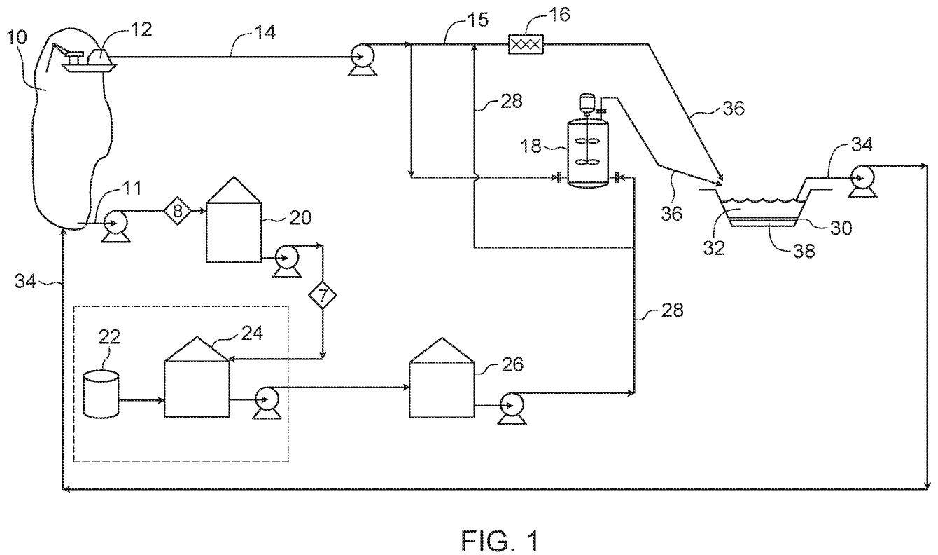

With reference now to FIG. 1, an embodiment of the present process is illustrated. In this embodiment, tailings are derived from an oil sand tailings pond 10 using floating barge 12 having a submersible pump. A dredge could also be used. When deposited into oil sand tailings ponds, oil sand extraction tailings separate into an upper water layer, a middle tailings layer, and a bottom layer of settled solids. The middle tailings layer derived from oil sand tailings ponds is generally referred to as fluid fine tailings and after time mature fine tailings or MFT. In one embodiment, the MFT has a solids content ranging from about 30 wt % to about 45 wt. %. However, it should be understood that tailings treated according the process of the present invention are not necessarily obtained from a tailings pond and may also be obtained from ongoing oil sands extraction operations.

The process water 11 in tailings pond 10 is pumped to water tank 20 where it is used to form aqueous polymer from dry polymer 22 in polymer mixing tank 24. The aqueous polymer can be stored in polymer holding tank 26. The MFT 14 may be pumped through pipeline 15, where aqueous polymer 28 is added prior to mixing in static/in-line mixer 16, which mixer uses the energy contained within the flowing fluid stream to mix the aqueous polymer and MFT to form flocs. Typical designs of static mixers comprise plates, baffles, helical elements or geometric grids positioned at precise angles to direct flow and increase turbulence.

The MFT 14 may also be pumped to dynamic mixer 18, where the aqueous polymer 28 is added to the MFT and the two are mixed therein to form flocs. Dynamic mixing generally utilizes a motor driven mixing device such as an impeller to cause fluid mixing. It is understood, however, that other mixing devices such as a t-mixer could also be used.

The flocculated tailings 36 are then deposited into a containment cell 30, which contains a column of water, water column 32, therein. Water column 32 may be process water 11 from tailings pond 10. The flocs in the flocculated tailings are allowed to travel through the water column 32 and settle at the bottom of the containment cell 30 to form a layer of consolidated tailings 38. Water 34 may be continuously removed from the containment cell 30 to maintain the water column 32 at an optimal height and may be returned to tailings pond 10. In one embodiment, water 34 is removed after deposition of tailings is completed.

Exemplary embodiments of the present invention are described in the following Examples, which are set forth to aid in the understanding of the invention, and should not be construed to limit in any way the scope of the invention as defined in the claims which follow thereafter.

### Example 1

Tests were performed to compare depositing flocculated MFT through a water column in a 20 L container and depositing the flocculated MFT into an empty container (no water column). The MFT used had a solids content of 31.2 wt. % and was flocculated using approximately 1000 g flocculant per tonne of MFT solids. The flocculant was prepared in a process water solution at a concentration of 0.04% by weight. The mixing was optimized with a dynamic in-line mixer. The water column in the 20 L container was approximately ¼ of the height of the container. The flocculated tailings were allowed to settle for approximately 2 weeks and the solids content of the resulting deposits determined. When no water column was used, the resulting deposit comprised 37.6 wt. % average solids. However, when a water column was used, the resulting deposit comprised 42.5 wt. % average solids. In another test, the depth of the water column was doubled and the solids content of the resulting deposit was found to be 44.4 wt. % solids.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

We claim:

1. A process for dewatering tailings, comprising:
(a) mixing the tailings with an effective amount of a flocculant to form flocculated tailings;
(b) providing a containment area having a water column therein; and
(c) depositing the flocculated tailings into the containment area such that the flocculated tailings pass through the water column to allow the flocs to form a compact structure below the water column and release water.

2. The process as claimed in claim 1, wherein the tailings are pre-treated with an inorganic multivalent cation prior to step (a).

3. The process as claimed in claim 2, wherein the inorganic multivalent cation is selected from the group consisting of calcium, magnesium, aluminium and iron.

4. The process as claimed in claim 1, wherein the flocculant and tailings are mixed in a pipe having an in-line dynamic or static mixer.

5. The process as claimed in claim 1, wherein the flocculant and tailings are mixed in a mixing tank.

6. The process as claimed in claim 1, wherein the tailings are oil sand fluid fine tailings having a solids content in the range of about 10 wt. % to about 45 wt. %.

7. The process as claimed in claim 1, wherein the tailings are mature fine tailings having a solids content in the range of about 30 wt. % to about 45 wt. %.

8. The process as claimed in claim 1, wherein the flocculant is a water soluble polymer having a moderate to high molecular weight and an intrinsic viscosity of at least 3 dl/g (measured in 1N NaCl at 25° C.).

9. The process as claimed in claim 8, wherein the polymeric flocculant is cationic, non-ionic, amphoteric, or anionic.

10. The process as claimed in claim 8, wherein the polymeric flocculant is in an aqueous solution at a concentration of about between 0.05 and 5% by weight of polymeric flocculant.

11. The process as claimed in claim 10, wherein the polymeric flocculant solution will be used at a concentration of about 1 g/L to about 5 g/L.

12. The process as claimed in claim 1, wherein the flocculant is a polymeric flocculant and is added to the tailings at a dosage in the range from 10 grams to 10,000 grams per tonne of tailings solids.

13. The process as claimed in claim 12, wherein the dosage ranges from about 400 to about 1,000 grams per tonne of tailings solids.

14. The process as claimed in claim 1, wherein the flocculant is a charged or uncharged polyacrylamide including a high molecular weight polyacrylamide-sodium polyacrylate co-polymer with about 25-35% anionicity.

15. The process as claimed in claim 14, wherein the polyacrylamide-sodium polyacrylate co-polymers may be branched or linear and have molecular weights which can exceed 20 million.

16. The process as claimed in claim 1, further comprising:
(d) removing the water column once the compact structure has formed and water has been released.
